(19) United States
(12) Patent Application Publication
(10) Pub. No.: US 2004/0228525 A1
(43) Pub. Date: Nov. 18, 2004

(54) Method for color transformation by way of color profiles

(76) Inventor: Uwe-Jens Krabbenhoft, Landwehr Gem. Quarnbek (DE)

Correspondence Address: LERNER AND GREENBERG, PA, P O BOX 2480, HOLLYWOOD, FL, 33022-2480, US

(21) Appl. No.: 10/767,577

(22) Filed: Jan. 29, 2004

(30) Foreign Application Priority Data
May 17, 2003 (DE) 103 22 378.9

(51) Int. Cl. G06K 9/00

(52) U.S. Cl. 382/162

(57) ABSTRACT

In the field of electronic reproduction technology there exists a need for the color transformation of color values of a first device-dependent color space into color values of a second device-dependent color space. The transformation is effected with color profiles in accordance with the ICC standard, and with a view to render the visual impression of the colors reproduced in the two color spaces substantially identical. The color transformation with a relative calorimetric rendering intent, defined in accordance with the ICC standard, is supplemented by a chromatic adaptation transformation based on the white points of the color spaces, with which the chromatic adaptation of the visual system in the case of different white points is taken into account.

### BACKGROUND OF THE INVENTION

Field of the Invention

The invention lies in the field of electronic reproduction technology and relates to a method for color transformation of color values of a first device-dependent color space into color values of a second device-dependent color space. The transformation is effected using color profiles in accordance with the ICC standard. The color profiles describe the characteristic properties of the color spaces. Such color transformations are carried out, for example, to adapt color values, which have been produced for a first printing process to a second printing process, so that the visual impression of the printed colors in the two printing processes is substantially identical.

In reproduction technology, printing originals for printed pages are produced which contain all the elements to be printed, such as text, graphics and images. In the case of the electronic production of the printing originals, these elements are present in the form of digital data. For an image, the data are produced, for example, by the image being scanned point by point and row by row in a scanner. Each image point is broken down into color components and the color components are digitized.

Images are usually broken down in a scanner into the color components red, green, and blue [R, G, B], that is to say into the components of a three-dimensional color space. However, for color printing, other color components are needed. In the case of four-color printing, these are the printing inks cyan, magenta, yellow, and black [C, M, Y, K], which form the components of a four-dimensional color space. For this purpose, the image data from the. RGB color space of the scanner must be transformed into the CMYK color space of the printing process to be used. If the CMYK image data produced for a printing process is to be displayed on a monitor, in a so-called soft proof, or if it is to be output in advance on an inkjet printer as a proof, for example, then in each case further color transformations are necessary in order that the colors are reproduced as accurately as possible in accordance with the subsequent printing process that is used for the edition printing.

Such color transformations are needed in reproduction technology, since all devices and processes have specific restrictions and special features in the representation and reproduction of the colors, and the devices and processes have various such properties. Therefore, for various devices and processes, such as scanners, monitors, proof output devices, printing processes and so on, there are different color spaces which in each case describe the color properties of the device or process in an optimum manner and which are designated device-dependent color spaces. In addition to the device-dependent color spaces there are also device-independent color spaces, which are based on the human perception properties of what is known as a normal observer. Such color spaces are, for example, the XYZ color space defined by the CIE standardization commission (Commission Internationale d'Eclairage) or the LAB color space derived from this. If it is desirable to know whether two colors will be perceived as being identical or different by the human eye under identical environmental conditions, in particular under identical illumination, then the measurement of the XYZ or LAB color components is sufficient for this. The LAB color components form a color space with a lightness axis [L] and two color axes [A, B], which can be imagined in the plane of a color circle through the center of which the lightness axis runs. The LAB color components are related to the XYZ color components via non-linear conversion equations.

A device or color processing process can be characterized with respect to its color properties by all the possible value combinations of the associated device-dependent color space being assigned the XYZ color components which are seen by a human in the colors produced with these value combinations. For a printing process, the various CMYK value combinations in each case produce a different printed color. Using a color measuring instrument, the XYZ components of the printed colors can be determined and assigned to the CMYK value combinations. Such an assignment, which places the device-dependent colors produced with a device or process in a relationship with a device-independent color space (XYZ or LAB) is designated a color profile, in the case of a printing process, an output color profile.

The definition and data formats for color profiles have been standardized by the ICC (International Color Consortium—Specification ICC.1:2001-12; File Format for Color Profiles (Version 4.0.0)). In an ICC color profile, the association between the color spaces is stored in both directions, for example the association XYZ=f1(CMYK) and the inverted association CMYK=f2(XYZ). The assignment defined with a color profile can be implemented with the aid of a look-up table. If, for example, the CMYK color components of a printing process are to be assigned the XYZ color components, the look-up table must have, for each possible value combination of the CMYK color components, a storage location in which the associated XYZ color components are stored. However, this simple assignment method has the disadvantage that the look-up table can become very large. If each of the color components CMYK is digitized with 8 bits, that is to say has 2⁸=256 density steps, there are 256⁴=4,294,967,296 possible value combinations of the color components. The look-up table would therefore have to have 4,294,967,296 storage cells each with 6 bytes word length (in each case two bytes for X, Y, Z). Therefore, the look-up table reaches a size of 25.8 gigabytes.

In order to reduce the size of the look-up table, a combination of a look-up table and interpolation method is therefore used in order to implement an appropriate color transformation. The look-up table has stored therein, instead of the associations for all the possible value combinations of the CMYK color components, only those for a coarser, regular grid of reference points in the CMYK color space. The grid is formed by only each k^{th} value being taken as a grid point in each component direction. For each grid point, the associated components of the XYZ color space are stored in the look-up table as reference points. For CMYK value combinations which lie between the grid points, the associated XYZ values are interpolated from the adjacent reference points.

The assignments given in the color profiles between the device-dependent color spaces and a device-independent color space can be used for the color transformation between the device-dependent color spaces, so that, for example, the color values [C1, M1, Y1, K1] of a first printing process can be converted into the color values [C2, M2, Y2, K2] of a second printing process in such a way that the second print, according to the visual impression, has the same colors as the first print. FIG. 1 illustrates the principle of such a color trans-formation for a printing process adaptation according to the prior art in a block diagram. A first color transformation 1 from the color values [C1, M1, Y1, K1] of the first printing process into XYZ color values, and a second color transformation 2 from the XYZ color values into the color values [C2, M2, Y2, K2] of the second printing process are carried out one after another. The two color transformations 1 and 2 can also be combined to form an equivalent color transformation 3, which directly associates the color values [C1, M1, Y1, K1] and the color values [C2, M2, Y2, K2] with one another. Since, via the device-independent XYZ intermediate color space, in each case the color values [C1, M1, Y1, K1] and [C2, M2, Y2, K2] which yield the same XYZ color values are assigned to one another, the associated printing inks in the two printing processes are perceived as largely visually identical within the gamut of printing inks.

In the ICC specification, the device-independent color space via which the device-dependent color spaces are linked with one another during a color transformation is designated a profile connection space (PCS). The profile connection space is the interface between the color profiles of the devices and processes. It is defined as an ideal original reference color space in an ideal viewing environment. The basis is formed by the CIE 1931 XYZ and CIE 1976 LAB standard color spaces defined by the CIE. The white point of the profile connection space is defined by the standard illuminant D50, which is usual in graphic technology, that is to say illumination with a light source at 5000 Kelvin. This white point WPD50 has the XYZ color values:

X_{WPD50}=0.9642 Y_{WPD50}=1.0000 Z_{WPD50}=0.8249 (1)

For the associations described in the ICC profiles between a device-dependent color space and the profile connection space there are variants which are used depending on the rendering intent. These rendering intents are designated “relative calorimetric,” “absolute calorimetric,” “perceptual,” and “saturation.” They differ, inter alia, in what is known as the gamut mapping incorporated into the color profiles. Gamut mapping designates the method or the strategy with which the different color gamuts of the device-dependent color spaces are matched to one another. For example, not all the light and saturated colors which can be displayed on a monitor are also printable, in particular if the print is made on poor and relatively gray paper, for example on newsprint. Then, by way of the association of the color profile, the non-printable monitor colors must be converted into similar colors at the edge of the color gamut of the printable colors, so that an overall harmonic color impression without subjectively perceived color distortions is produced.

The object of the so-called perceptual rendering intent is, in addition to the visually perceived color identity, also to take into account further properties that are important for image reproduction, such as contrast, detail drawing, real observation environment, in the mapping into the profile connection space. The saturation rendering intent predominantly preserves the pure and saturated colors and is used in the reproduction of graphics. The relative calorimetric rendering intent is used, for example, in order, by using a color transformation, to map different printing processes on one another, the color gamut and the lightness gamut of the target process being utilized to the full. In particular, this means that the white point of the source process, that is to say the paper white, is mapped to the white point of the target process. If the white point of the target process is lighter than the white point of the source process then, after the color transformation, the colors are reproduced more brightly and more brilliantly when printing with the target process. With the absolute calorimetric rendering intent, on the other hand, during the color transformation, the white point and the XYZ color values of the source process are reproduced unchanged when printing with the target process. The precondition for this is that the printable color gamut and the lightness range of the target process are greater than the gamut of the source process. The absolute calorimetric rendering intent is therefore used to reproduce a source printing process as an exact-color and mandatory proof with a target printing process, for example on a high quality inkjet printer.

In the association tables drawn up for the relative calorimetric rendering intent, the XYZ color values of the profile connection space assigned to the device-dependent color values are scaled in such a way that the possible value range of the profile connection space is utilized to the full. This means in particular that the measured white point WP1 of the device-dependent color space (media white point) in the profile connection space is assigned the white point WPD50. If the white point WP1 of a source printing process, for example newspaper printing, has the measured XYZ color values [X_{WP1}, Y_{WP1}, Z_{WP1}], then when creating the color profile, all the color values [X1, Y1, Z1] measured for various value combinations [C1, M1, Y1, K1] of the color fields on a test original are scaled component by component with the ratio of the white points WPD50 and WP1, in order to obtain the associated color values [X_{PCS1}, Y_{PCS1}, Z_{PCS1}] of the profile connection space.

X_{PCS1}=X1×X_{WPD50}/X_{WP1}

Y_{PCS1}=Y1×Y_{WPD50}/Y_{WP1}

Z_{PCS1}=Z1×Z_{WPD50}/Z_{WP1} (2)

Likewise, when setting up the color profile for a target printing process with the white point WP2, for example an offset print, the color values [X2, Y2, Z2] measured for various value combinations [C2, M2, Y2, K2] are scaled component by component with the ratio of the white points WPD50 and WP2, in order to obtain the associated color values [X_{PCS2}, Y_{PCS2}, Z_{PCS2}] of the profile connection space.

X_{PCS2}=X2×X_{WPD50}/X_{WP2}

Y_{PCS2}=Y2×Y_{WPD50}/Y_{WP2}

Z_{PCS2}=Z2×Z_{WPD50}/Z_{WP2} (3)

Since, during the linking of the color profiles according to FIG. 1, in each case identical value combinations [X_{PCS1}, Y_{PCS1}, Z_{PCS1}] and [X_{PCS2}, Y_{PCS2}, Z_{PCS2}] are associated with one another in the profile connection space, the result during the color transformation of the source process into the target process in accordance with the relative colorimetric rendering intent is the relationship:

X2=X1×X_{WP2}/X_{WP1}

Y2=Y1×Y_{WP2}/Y_{WP1}

Z2=Z1×Z_{WP2}/Z_{WP1} (4)

The device-dependent color values [C1, M1, Y1, K1] of the source process are therefore transformed into the device-dependent color values [C2, M2, Y2, K2] of the target process in such a way that the XYZ color values corresponding to them are scaled component by component in the ratio of the white point values. In particular, the relationship (4) results in the white point WP1 of the source process being transformed into the white point WP2 of the target process.

Such simple scaling of the XYZ color values, which results in accordance with the ICC specification for the relative calorimetric rendering intent, is not optimal if the white points of the source process and of the target process are relatively far from each other. In this case, the relative distances of the colors which are printed on the media with the different white points are not perceived as equivalent to the source process, in spite of the linear scaling of the XYZ color values in the target process, since the human visual system, when viewing the colors of the target printing process, carries out a chromatic adaptation which depends on the white point.

### SUMMARY OF THE INVENTION

It is accordingly an object of the invention to provide a color transformation method, which overcomes the above-mentioned disadvantages of the heretofore-known devices and methods of this general type and which, for the relative calorimetric rendering intent, specifies an improved method for color transformation from a source process into a target process which operates on the basis of given color profiles in accordance with the ICC specification for the two processes and, even in the case of different white points of the processes, a mapping of the colors which is perceived to be harmonic and equivalent to the source process being produced in the target process.

With the foregoing and other objects in view there is provided, in accordance with the invention, a method of transforming color values of a first device-dependent color space into color values of a second device-dependent color space, to effect a substantially identical visual impression of colors reproduced in the first and second color spaces. The method comprises the following steps:

providing a first color profile characterizing the first color space and providing a second color profile characterizing the second color space;

wherein the first and second color profiles specify an association between the color values of the first and second device-dependent color spaces and the color values of a device-independent color space;

wherein a white point of the first device-dependent color space, a white point of the second device-dependent color space, and a white point of the device-independent color space are described by device-independent white point values;

determining relative color values of the device-independent color space from the color values of the first device-dependent color space by way of the association specified in the first color profile;

converting the relative color values into absolute color values in a ratio corresponding to a ratio of the values of the white point of the first device-dependent color space and the white point of the device-independent color space;

determining chromatically adapted color values from the absolute color values by way of a chromatic adaptation transformation;

converting the chromatically adapted color values into relative chromatically adapted color values in a ratio corresponding to a ratio of the values of the white point of the device-independent color space and the white point of the second device-dependent color space; and

determining color values of the second device-dependent color space from the relative chromatically adapted color values by way of the association specified in the second color profile.

In other words, the objects of the invention are achieved with the method which, when linking the ICC color profiles of source process and target process, a chromatic adaptation transformation is carried out. The transformation takes into account the chromatic adaptation of the visual system on the basis of the different white points of the processes. In this case, it is advantageous that the content of the association tables of the ICC color profiles does not need to be changed for this purpose.

In accordance with an added feature of the invention, the chromatic adaptation transformation is effected with a Bradford matrix (B), where:

$$B = ( \begin{matrix}0.8951 & 0.2664 & - 0.1614 \\ - 0.7502 & 1.7135 & 0.0367 \\ 0.0389 & - 0.0685 & 1.0296\end{matrix} )$$

In accordance with an additional feature of the invention, the chromatic adaptation transformation is effected with a von Kries matrix.

In accordance with another feature of the invention, the system uses color profiles formatted in accordance with the ICC specification (International Color Consortium).

In accordance with a concomitant feature of the invention, the associations contained in the color profiles between color values of the device-dependent color space and color values of the device-independent color space are left unchanged.

Other features which are considered as characteristic for the invention are set forth in the appended claims.

Although the invention is illustrated and described herein as embodied in a method for color transformation by means of color profiles, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram for a prior art color transformation in accordance with the ICC specification; and

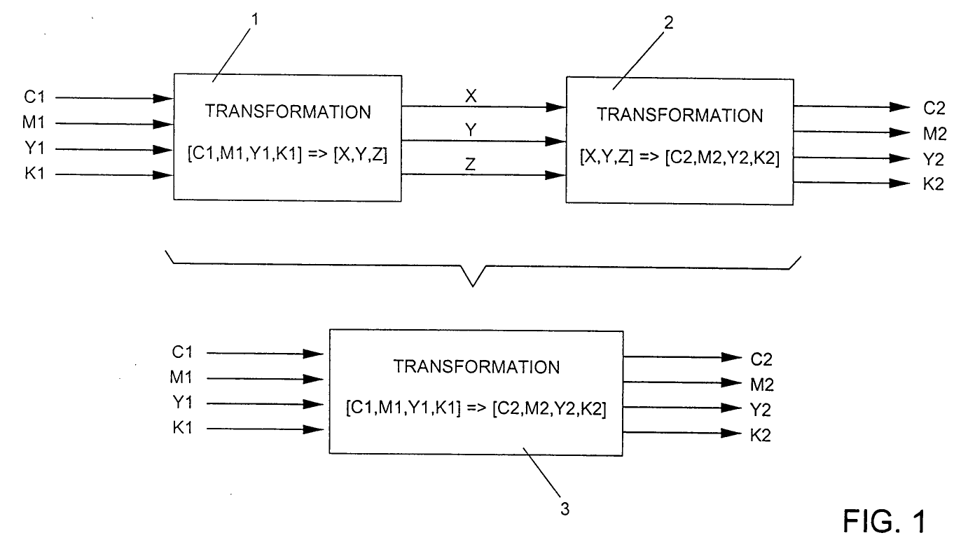

FIG. 2 is a flowchart for the working steps of the novel method according to the invention.

### DESCRIPTION OF THE PREFERRED EMBODIMENTS

The chromatic adaptation of the visual system is based on a change in the sensitivity of the color receptors (cones) in the retina for the three primary colors red, green and blue. During the adaptation, the sensitivities of the three color receptor types change independently of one another in such a way that, following the adaptation, the paper white of an image printed with the target process is once more perceived to be white, although the paper white according to the XYZ color measured values is not exactly white but, for example, somewhat yellowish. As a result of this change in the receptor sensitivities, the sensor signals of the color receptors during the perception of the colors also change accordingly. The chromatic adaptation is comparable, for example, with the automatic white balancing in video cameras or digital photography.

In order to take into account the chromatic adaptation, for example from the white point WP1 to the white point WPD50 during the color transformation, the XYZ color values must be converted into the sensor signals L, M, S of the color receptors. From the specialist literature, it is known that this can be achieved by a matrix multiplication. Known suitable matrices are the von Kries matrix and the Bradford matrix. As an example, the Bradford matrix [B] is used here.

$$B = ( \begin{matrix}0.8951 & 0.2664 & - 0.1614 \\ - 0.7502 & 1.7135 & 0.0367 \\ 0.0389 & - 0.0685 & 1.0296\end{matrix} ) \qquad ( 5 )$$

Using this, the receptor signals [L1, M1, S1] for the color values [X1, Y1, Z1] of a color of the source process are given by:

$$( \begin{matrix}L1 \\ M1 \\ S1\end{matrix} ) = B \times ( \begin{matrix}X1 \\ Y1 \\ Z1\end{matrix} ) \qquad ( 6 )$$

In a next step, the XYZ color values of the white points WP1 and WPD50 are converted into the corresponding receptor signals.

$$\begin{matrix}( \begin{matrix}{L}_{WP1} \\ {M}_{WP1} \\ {S}_{WP1}\end{matrix} ) = B \times ( \begin{matrix}{X}_{WP1} \\ {Y}_{WP1} \\ {Z}_{WP1}\end{matrix} ) & ( 7 ) \\ ( \begin{matrix}{L}_{WPD50} \\ {M}_{WPD50} \\ {S}_{WPD50}\end{matrix} ) = B \times ( \begin{matrix}{X}_{WPD50} \\ {Y}_{WPD50} \\ {Z}_{WPD50}\end{matrix} ) & ( 8 )\end{matrix}$$

A diagonal matrix [D1] is formed from the ratios of the receptor signals for the white points.

$$D1 = ( \begin{matrix}\frac{{L}_{WPD50}}{{L}_{WP1}} & 0 & 0 \\ 0 & \frac{{M}_{WPD50}}{{M}_{WP1}} & 0 \\ 0 & 0 & \frac{{S}_{WPD50}}{{S}_{WP1}}\end{matrix} ) \qquad ( 9 )$$

By multiplying the receptor signals [L1, M1, S1] by this diagonal matrix [D1], the receptor signals [L50, M50, S50] adapted for the white point WPD50 are obtained.

$$( \begin{matrix}L50 \\ M50 \\ S50\end{matrix} ) = D1 \times ( \begin{matrix}L1 \\ M1 \\ S1\end{matrix} ) \qquad ( 10 )$$

Finally, from this, by multiplying by the inverted Bradford matrix, the adapted XYZ color values [X50, Y50, Z50] are obtained.

$$( \begin{matrix}X50 \\ Y50 \\ Z50\end{matrix} ) = {B}^{- 1} \times ( \begin{matrix}L50 \\ M50 \\ S50\end{matrix} ) \qquad ( 11 )$$

For improved clarity, the chain of matrix operations for the chromatic adaptation transformation of the source process from the white point WP1 to the white point WPD50 will be summarized once more.

$$( \begin{matrix}X50 \\ Y50 \\ Z50\end{matrix} ) = {B}^{- 1} \times D1 \times B \times ( \begin{matrix}X1 \\ Y1 \\ Z1\end{matrix} ) \qquad ( 12 )$$

In the same way, the color values [X50, Y50, Z50] adapted to the white point WPD50 can be adapted to the white point WP2 of the target process. For this purpose, a corresponding diagonal matrix [D2] must be formed from the receptor signals of the white points WPD50 and WP2.

$$D2 = ( \begin{matrix}\frac{{L}_{WP2}}{{L}_{WPD50}} & 0 & 0 \\ 0 & \frac{{M}_{WP2}}{{M}_{WPD50}} & 0 \\ 0 & 0 & \frac{{S}_{WP2}}{{S}_{WPD50}}\end{matrix} ) \qquad ( 13 )$$

The chain of matrix operations for the chromatic adaptation transformation from the white point WPD50 to the white point WP2 of the target process is therefore given by:

$$( \begin{matrix}X2a \\ Y2a \\ Z2a\end{matrix} ) = {B}^{- 1} \times D2 \times B \times ( \begin{matrix}X50 \\ Y50 \\ Z50\end{matrix} ) \qquad ( 14 )$$

The color values [X2a, Y2a, Z2a] are the chromatically adapted XYZ color values of the target process. As a result of the sequential execution of the relationships (12) and (14), the color values [X1, Y1, Z1] of a color of the source process are converted into the chromatically adapted XYZ color values [X2a, Y2a, Z2a] of the target process. The entire chain of matrix operations is:

$$( \begin{matrix}X2a \\ Y2a \\ Z2a\end{matrix} ) = {B}^{- 1} \times D2 \times B \times {B}^{- 1} \times D1 \times B \times ( \begin{matrix}X1 \\ Y1 \\ Z1\end{matrix} ) \qquad ( 15 )$$

It can easily be seen that this chain can be simplified to:

$$( \begin{matrix}X2a \\ Y2a \\ Z2a\end{matrix} ) = {B}^{- 1} \times D3 \times B \times ( \begin{matrix}X1 \\ Y1 \\ Z1\end{matrix} ) \qquad ( 16 )$$

where [D3] is a diagonal matrix formed from the receptor signals of the white points WP1 and WP2.

$$D3 = ( \begin{matrix}\frac{{L}_{WP2}}{{L}_{WP1}} & 0 & 0 \\ 0 & \frac{{M}_{WP2}}{{M}_{WP1}} & 0 \\ 0 & 0 & \frac{{S}_{WP2}}{{S}_{WP1}}\end{matrix} ) \qquad ( 17 )$$

For further simplification, the sequence of operations [B]⁻¹×[D3]×[B] can be combined to form a chromatic adaptation matrix [FU].

$$( \begin{matrix}X2a \\ Y2a \\ Z2a\end{matrix} ) = FU \times ( \begin{matrix}X1 \\ Y1 \\ Z1\end{matrix} ) \qquad ( 18 )$$

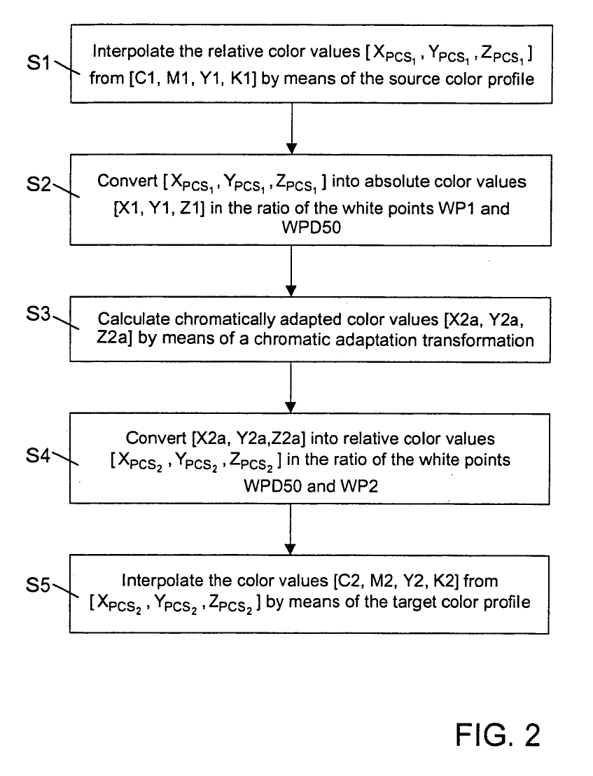

The entire sequence of working steps of the method according to the invention for color transformation in accordance with the relative calorimetric rendering intent from device-dependent color values [C1, M1, Y1, K1] of a source process to the device-dependent color values [C2, M2, Y2, K2] of a target process, taking into account the chromatic adaptation to the white point of the target process, will be explained using FIG. 2. The color profiles of the source process and of the target process in accordance with the ICC specification are given. They each contain an association table of the color values [C, M, Y, K] into the color values [X_{PCS}, Y_{PCS}, Z_{PCS}] of the profile connection space and an inverted association table, with which color values [X_{PCS}, Y_{PCS}, Z_{PCS}] of the profile connection space can be converted into the corresponding device-dependent color values [C, M, Y, K]. The association tables are designated “AToB1Tag” and “BToA1Tag” in the ICC specification. Furthermore, the color profiles contain the XYZ color values of the white points (media white point) of the processes, that is to say the values [X_{WP1}, Y_{WP1}, Z_{WP1}] for the white point WP1 of the source process and the values [X_{WP2}, Y_{WP2}, Z_{WP2}] for the white point WP2 of the target process. In step S1, by way of the association table “AToB1Tag” of the source process, given device-dependent color values [C1, M1, Y1, K1] are used to interpolate the associated device-independent color values [X_{PCS1}, Y_{PCS1}, Z_{PCS1}]. Since these are relative color values based on the white point WPD50, in step S2 they are converted component by component into the absolute color values [X1, Y1, Z1] in the ratio of the white point values WP1 and WPD50.

X1=X_{PCS1}×X_{WP1}/X_{WPD50}

Y1=Y_{PCS1}×Y_{WP1}/Y_{WPD50}

Z1=Z_{PCS1}×Z_{WP1}/Z_{WPD50} (19)

In step S3, using the absolute color values [X1, Y1, Z1] of the source process, the chromatic adaptation transformation is carried out in accordance with the relationship (16) or the corresponding relationship (18). The chromatically adapted color values [X2a, Y2a, Z2a] for the target process are therefore obtained. These absolute values are converted into the relative color values [X_{PCS2}, Y_{PCS2}, Z_{PCS2}] in the ratio of the white point values WPD50 and WP2 in step S4.

X_{PCS2}=X2a×X_{WPD50}/X_{WP2}

Y_{PCS2}=Y2a×Y_{WPD50}/Y_{WP2}

Z_{PCS2}=Z2a×Z_{WPD50}/Z_{WP2} (20)

Finally, in step S5, by way of the association table “BToA1Tag” of the target process, the device-dependent color values [C2, M2, Y2, K2] for the target process are interpolated from these values.

The method according to the invention has been explained using the example of a color transformation from a CMYK source process into a CMYK target process. It will be readily understood, however, that the invention is not restricted to CMYK color spaces but can also be carried out for color transformations between any desired device-dependent color spaces for which the appropriate ICC profiles are given. It is also not absolutely necessary for the association tables “AToB1Tag” and “BToA1Tag” of the color profiles to be used. ICC color profiles for simple calculations, instead of or in addition to the association tables, can also contain transformation matrices with which, by way of simple matrix multiplications, the association between the device-dependent color values and the associated color values of the profile connection space can be determined. For this case, the method according to the invention can be modified in that, in the working steps S1 and S5 (FIG. 2), the tabular interpolations are replaced by the appropriate matrix multiplications with the transformation matrices.

I claim:

1. A method of transforming color values of a first device-dependent color space into color values of a second device-dependent color space, to effect a substantially identical visual impression of colors reproduced in the first and second color spaces, the method which comprises:
providing a first color profile characterizing the first color space and providing a second color profile characterizing the second color space;
wherein the first and second color profiles specify an association between the color values of the first and second device-dependent color spaces and the color values of a device-independent color space;
wherein a white point of the first device-dependent color space, a white point of the second device-dependent color space, and a white point of the device-independent color space are described by device-independent white point values;
determining relative color values of the device-independent color space from the color values of the first device-dependent color space by way of the association specified in the first color profile;
converting the relative color values into absolute color values in a ratio corresponding to a ratio of the values of the white point of the first device-dependent color space and the white point of the device-independent color space;
determining chromatically adapted color values from the absolute color values by way of a chromatic adaptation transformation;
converting the chromatically adapted color values into relative chromatically adapted color values in a ratio corresponding to a ratio of the values of the white point of the device-independent color space and the white point of the second device-dependent color space; and
determining color values of the second device-dependent color space from the relative chromatically adapted color values by way of the association specified in the second color profile.

2. The method according to claim 1, which comprises carrying out the chromatic adaptation transformation by way of a Bradford matrix (B), with:
$$B = ( \begin{matrix}0.8951 & 0.2664 & - 0.1614 \\ - 0.7502 & 1.7135 & 0.0367 \\ 0.0389 & - 0.0685 & 1.0296\end{matrix} ) .$$

3. The method according to claim 1, which comprises carrying out the chromatic adaptation transformation in accordance with a von Kries matrix.

4. The method according to claim 1, which comprises using color profiles formatted in accordance with the ICC specification (International Color Consortium).

5. The method according to claim 1, which comprises leaving unchanged the associations contained in the color profiles between the color values of the device-dependent color space and the color values of the device-independent color space.
